(19) United States
(12) Patent Application Publication
(10) Pub. No.: US 2015/0034837 A1
(43) Pub. Date: Feb. 5, 2015

(54) LIFETIME ION SOURCE

(71) Applicant: Varian Semiconductor Equipment Associates, Inc., Gloucester, MA (US)

(72) Inventors: Bon-Woong Koo, Andover, MA (US); William T. Levay, Rockport, MA (US); Richard M. White, Newmarket, NH (US); Eric R. Cobb, Danvers, MA (US)

(73) Assignee: Varian Semiconductor Equipment Associates, Inc., Gloucester, MA (US)

(21) Appl. No.: 13/956,798

(22) Filed: Aug. 1, 2013

(51) Int. Cl. H01J 27/02; H01J 27/20

(52) U.S. Cl. CPC H01J 27/022; H01J 27/205
USPC 250/424; 250/427

(57) ABSTRACT

An ion source includes an ion source chamber, a gas source to provide a fluorine-containing gas species to the ion source chamber and a cathode disposed in the ion source chamber configured to emit electrons to generate a plasma within the ion source chamber. The ion source chamber and cathode are comprised of a refractory metal. A phosphide insert is disposed within the ion source chamber and presents an exposed surface area that is configured to generate gas phase phosphorous species when the plasma is present in the ion source chamber, wherein the phosphide component is one of boron phosphide, tungsten phosphide, aluminum phosphide, nickel phosphide, calcium phosphide and indium phosphide.

### FIELD

Embodiments relate to the field of ion implantation. More particularly, the present embodiments relate to apparatus and method for producing improved ion sources.

### BACKGROUND

Ion sources such as indirectly heated cathode (IHC) ion sources are used to generate a variety of ion species including dopant ions that are used for implantation into semiconductor substrates to control their electronic properties. Many precursors for dopant ions contain halogen species such as fluorine (BF₃, B₂F₄, GeF₄, PF₃, SiF₄, AsF₅, etc), which can create a corrosive environment within an ion source. In particular, the lifetime of an IHC ion source is typically limited by the lifetime of the cathode and repeller components of the ion source. During operation, portions of the ion source that are exposed to halogens such as fluorine-containing gas species may be subject to etching. For example, ion source components may be constructed at least partially from tungsten that is exposed to fluorine species during operation. A halogen cycle may be established that removes tungsten from relatively colder surfaces within the ion source and redeposits the tungsten on relatively hotter surfaces, such as hot electrode surfaces or chamber walls. As a result, an uncontrollable growth of tungsten may occur on some electrode surfaces, which can result in glitching during operation of the ion source. Glitching is a phenomenon in which smooth operation of an ion source is disrupted by arcing that occurs either inside the ion source or in the ion extraction system. Glitching is exacerbated, for example, when sharp tungsten protuberances are grown on electrodes surface. Because the electric field is enhanced by orders of magnitude at the surface of protuberances, such sharp protuberances may readily generate unipolar or bipolar arc discharges (arc plasmas). Moreover, as irregular growth of redeposited metallic material proceeds, such growth may result in electrical shorting between electrodes and chamber walls of the ion source, making ion source operation impossible.

In particular, high-throughput, boron ion (B⁺) implantation that employs processes gasses that contain fluorine may experience increased glitching over time during operation. This may increase down time of an ion implantation apparatus and increase production and equipment costs. It is with respect to the above-referenced considerations that the present improvements have been needed.

### SUMMARY

Embodiments are directed to methods and apparatus for improved ion source performance. In one embodiment an ion source includes an ion source chamber, a gas source to provide a fluorine-containing gas species to the ion source chamber, a cathode disposed in the ion source chamber and configured to emit electrons to generate a plasma within the ion source chamber, the ion source chamber and cathode comprising a refractory metal; and a phosphide insert disposed within the ion source chamber and presenting an exposed surface area that is configured to generate gas phase phosphorous species when the plasma is present in the ion source chamber, wherein the phosphide component is one of boron phosphide, tungsten phosphide, indium phosphide, aluminum phosphide, nickel phosphide, and calcium phosphide.

In another embodiment, a method to operate an ion source includes providing a fluorine-containing gas species that contain fluorine to an ion source chamber comprising refractory metal, providing a cathode voltage to a refractory metal cathode in the ion source chamber to generate a plasma therein, and providing a phosphide insert within the ion source chamber, the phosphide insert presenting an exposed surface area that is configured to generate gas phase phosphorous species when the phosphide insert is exposed to the plasma, wherein the phosphide insert is one of boron phosphide, tungsten phosphide, indium phosphide, aluminum phosphide, nickel phosphide, and calcium phosphide.

### BRIEF DESCRIPTION OF THE DRAWINGS

FIG. 1 is a side cross-sectional view of an ion source consistent with various embodiments of the disclosure;

FIG. 2 is a side cross-sectional view of another ion source consistent with other embodiments of the disclosure;

FIG. 3 is a side cross-sectional view of a further ion source consistent with additional embodiments of the disclosure;

FIG. 4 is a side cross-sectional view of yet another ion source consistent with embodiments of the disclosure;

FIG. 5 is a flow chart of a method consistent with another embodiment of the disclosure; and

FIG. 6 is a top cross-sectional view of a further ion source consistent with additional embodiments of the disclosure.

### DETAILED DESCRIPTION

The present disclosure will now be described more fully hereinafter with reference to the accompanying drawings, in which some embodiments are shown. The subject of this disclosure, however, may be embodied in many different forms and should not be construed as limited to the embodiments set forth herein. Rather, these embodiments are provided so that this disclosure will be thorough and complete, and will fully convey the scope of the subject of this disclosure to those skilled in the art. In the drawings, like numbers refer to like elements throughout.

In various exemplary embodiments, ion sources are configured to improve performance and/or extend operating life of an ion source. Ion sources arranged according to the present embodiments include those ion sources that are constructed from refractory metal materials and designed to operate at elevated temperatures. Included among such ion sources are indirectly heated cathode (IHC) style ion sources in which a cathode may operate at temperatures in excess of 2000° C., such as about 2000° C.-3000° C. The ion sources may be constructed, at least in part, from tungsten, molybdenum, or other refractory metal. During operation, other portions of the ion source such as the ion source chamber walls may reach temperatures in the range of 500° C. to about 1000° C., and in particular between 500° C. to about 2000° C. In the present embodiments, an ion source constructed from refractory metal is provided with a phosphide insert placed within the ion source chamber that is exposed to a plasma in the ion source chamber when the ion source is in operation. During operation of the ion source using a fluorine-containing gaseous species (the term “gas species” is used interchangeably herein with “gaseous species”) such as BF₃ and/or B₂F₄, the phosphide insert is configured to reduce etching of refractory metal from within the ion source chamber in comparison to operation without the phosphide insert. This has the beneficial effect of reducing erosion of ion source components, as well as preventing refractory metal regrowth on hot surfaces of the ion source caused by redeposition of etched refractory metal. Examples of refractory metal include tungsten and molybdenum from which high temperature sources such as IHC ion sources are typically constructed. The reduction of the refractory metal regrowth, in turn, reduces or prevents instability such as glitching and/or shorting that may be otherwise generated by the regrown refractory metal deposits.

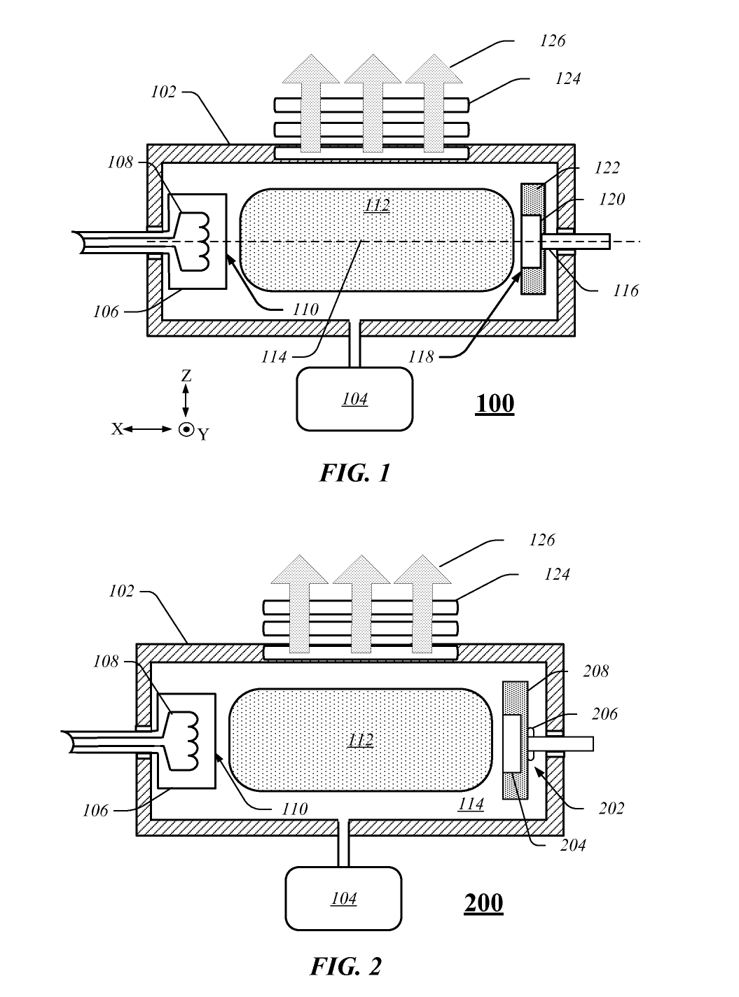

FIG. 1 depicts general features of an ion source 100 consistent with the present embodiments. The ion source 100 is an indirectly heated cathode (IHC) ion source that includes an ion source chamber 102, a gas source 104 which provides gaseous species to the ion source chamber 102. The ion source chamber 102 also houses a cathode 106, which is heated by a filament 108, such that during operation the cathode surface 110 reaches an elevated temperature and emits electrons when a voltage is applied to the cathode with respect to the ion source chamber 102. The cathode 106 is a refractory metal cathode that may be constructed from tungsten, molybdenum or other refractory metal. Various power supplies to power components of the ion source 100 as known in the art are omitted for clarity. The ion source chamber 102 is generally elongated along the X-direction in the Cartesian coordinate system shown and is configured to produce a plasma 112 that is generally elongated along the long axis 114 as shown. The ion source 100 further includes a repeller assembly 116 that is located opposite the cathode 106 and is disposed along the long axis 114 such that at least a front surface 118 is directly exposed to the plasma 112 during operation.

The repeller assembly 116 includes a repeller body 120 that is electrically conductive and configured to receive a repeller voltage. In various embodiments, the repeller voltage may be the same as or differ from the cathode voltage applied to cathode 106. The repeller assembly 116 further includes a phosphide insert 122 whose operation is detailed below. During operation, ions from the plasma 112 may be extracted through the extraction assembly 124 to generate the ion beam 126. The extraction assembly 124 may include a conventional arrangement of a faceplate having an aperture and various electrodes to extract the ion beam 126 at a desired energy.

Consistent with the present embodiments, the repeller assembly 116 performs multiple roles. The repeller assembly 116 may act as a conventional repeller that provides electron confinement by at least partially reflecting electrons emitted from cathode 106. In addition, by virtue of the phosphide insert 122, the repeller assembly 116 acts to extend the operation lifetime of the ion source 100 by reducing etching of refractory metal components of the ion source chamber during operation of the ion source. This reduced etching in turn leads to reduced etch-related glitching and other instabilities which may result in the need to terminate operation of an ion source.

The phosphide insert 122 is configured as a solid material that is at least partially exposed to the plasma 112 during operation and may be chemically etched and also sputtered by ion bombardment by various gaseous species present in the ion source chamber. In particular, the phosphide insert 122 may be employed to reduce etching of tungsten, molybdenum or other refractory material when the ion source 100 is operated with fluorine containing gases. The reduced etching leads to less redeposition and growth of metal deposits in the ion source chamber 102 and therefore lower probability of glitching and/or increased overall operation lifetime of the ion source 100. This is especially useful to increase the implant throughput when the ion source 100 is used to perform boron implantation which may employ gases such as BF₃ and/or B₂F₄ to generate implanting boron ions. For example, BF₃ gas may be provided to the ion source and BF₃ ions, BF₂ neutrals, BF₂ ions, BF neutrals, BF ions, and F neutrals, F positive and negative ions and other heavy neutral radicals or ions BₓF_{y} among others may all be produced through one or more processes from the parent BF₃ gas. Such species, in particular F* metastables or active neutrals, may cause etching of metal surfaces such as tungsten with the ion source chamber 102 that leads to metal redeposition and glitching during ion source operation.

The present inventors have found that the use of certain dilutant gaseous species such as PH₃ is effective to improve ion source performance by lowering ion source glitching during boron implantation using BF₃ or B₂F₄. In view of the above results, it is believed that phosphorous in particular may be effective in suppressing tungsten etch rate. However, the presence of hydrogen in the PH₃ dilutant gas may degrade the ion source efficiency by generating a significant amount of hydrogen ions at a given source operating condition, thereby decreasing ion current extracted from the ion source at a given source operating condition. In particular PH₃ gas generates some hydrogen ions (H⁺, H₂⁺, H₃⁺) and neutrals in addition to phosphorus. In order to meet the desired ion beam current, the ion extraction current from the ion source therefore has to be increased, which in turn may cause more glitching.

In the present embodiments, a solid phosphide insert 122 constructed from a material such as boron phosphide, tungsten phosphide, aluminum phosphide, nickel phosphide, calcium phosphide, or indium phosphide, among other materials, is used to reduce refractory metal etching within an ion source chamber and improve ion source performance. The phosphide insert does not include hydrogen and thereby does not provide a potential source of hydrogen that may reduce boron current. At a given ion source operating condition, in order to produce the same amount of phosphorus for glitch mitigation, the use of PH₃ is less efficient than using phosphide inserts due to a significant amount of hydrogen ions in the former. Phosphorous emitted either as neutrals or ions from the phosphide insert reacts with (or seals) hot surfaces, such as those in the ion source chamber 102 and extraction assembly 124, and thereby reduces etching from fluorine containing gases and/or ions. In operation, the plasma 112, which may be based upon BF₃ or B₂F₄, generates various plasma species including ions, neutrals, and excited neutrals, any of which may strike surfaces within the ion source chamber 102, and cause etching of surface material, including tungsten or other refractory metal. In particular, fluorine containing species are known to etch tungsten and other refractory metals, thereby creating etched tungsten containing species that may redeposit within the ion source chamber 102 and extraction assembly 124. At the same time, gas phase species exiting the plasma 112 may strike the phosphide insert 122 resulting in etched phosphorous-containing species (herein also referred to as “phosphorous species” or “gas phase phosphorous species”) being released into the ion source chamber 102. The phosphorous species may react with (or seal) tungsten or other etched metal species, preventing the etched metal species from etching and/or redepositing within the ion source chamber 102 or extraction assembly 124. The phosphide insert 122 thus acts as a continuous source of phosphorous species to suppress etching and/or redeposition of metal species that is etched during operation of the ion source 100.

As illustrated in FIG. 1, the phosphide insert 122 and repeller body 120 define the front surface 118 that faces plasma 112. The phosphide insert 122 only covers a fraction (<100%) of the front surface 118 of the repeller assembly 116 that faces the plasma 112. In the example of FIG. 1, the phosphide insert covers ˜50% or higher % of repeller assembly's surface, that is, of front surface 118. The material of phosphide insert 122 is typically semiconducting material or insulating at room temperature, but conductive at high temperature. Thus, when the ion source 100 is initially operational at low temperature, the phosphide insert 122 is insulating and the plasma 112 is electrostatically confined and controlled by the middle section of the repeller assembly 116, that is, the repeller body 120, which is tungsten or another refractory material, and is accordingly electrically conductive. Whether the phosphide insert 122 is electrically conducting or poorly conducting, the repeller body 120 thus provides a good electrical reference for a stable plasma, leading to stable ion source operation.

In addition to suppressing glitching, the phosphide insert may also increase ion source efficiency is some circumstances. In some embodiments as noted above, the phosphide insert 122 is a boron phosphide material. In these embodiments, the phosphide insert also provides a source of boron that may be etched during operation of the ion source 100, thereby yielding gas phase boron-containing species. The ion source 100 may ionize at least a portion of these gas phase boron-containing species, thereby increasing boron ion current when the ion source 100 is operated to generate boron ions for implantation.

Moreover, in embodiments in which the ion source 100 is deployed in a beamline ion implanter, mass analysis is typically performed downstream of the ion source 100. Accordingly, any phosphorous ions generated from the phosphide insert 122 and extracted in the ion beam 126 can be separated from a boron ion beam as it propagates down a beamline toward a substrate.

FIG. 2 illustrates another embodiment of an ion source 200. The ion source 200 includes components common with the ion source 100 except that the repeller assembly 202 of ion source 200 differs from the repeller assembly 116. In this case, the repeller assembly 202 includes an electrically conductive repeller body 204, a clamp 206 and phosphide insert 208. A central portion of the phosphide insert 208 is held between the repeller body 204 and clamp 206. The clamp 206 may be a screw or other structure that retains the phosphide insert 208. In various embodiments, the phosphide insert 208 may be removable from the repeller assembly 202 such that the phosphide insert 208 may be replaced with another insert as desired or needed. The shape of repeller body 204, clamp 206 and phosphide insert may also be configured to accommodate different thermal expansion rates between the different components of the repeller assembly 202 as ion source temperature changes during operation, without mechanical damage to the different components. In the embodiment shown the phosphide insert presents a planar surface facing toward the plasma 112 and cathode 106.

During operation of the ion source 200, the rate of etching of phosphorous material, that is, the rate at which phosphorus is generated to “scavenge” any etched metal, may be controlled by changing repeller voltage, changing other plasma conditions, and by changing the exposed surface area, which represents the total surface area of the phosphide insert 208 that is exposed to the plasma 112.

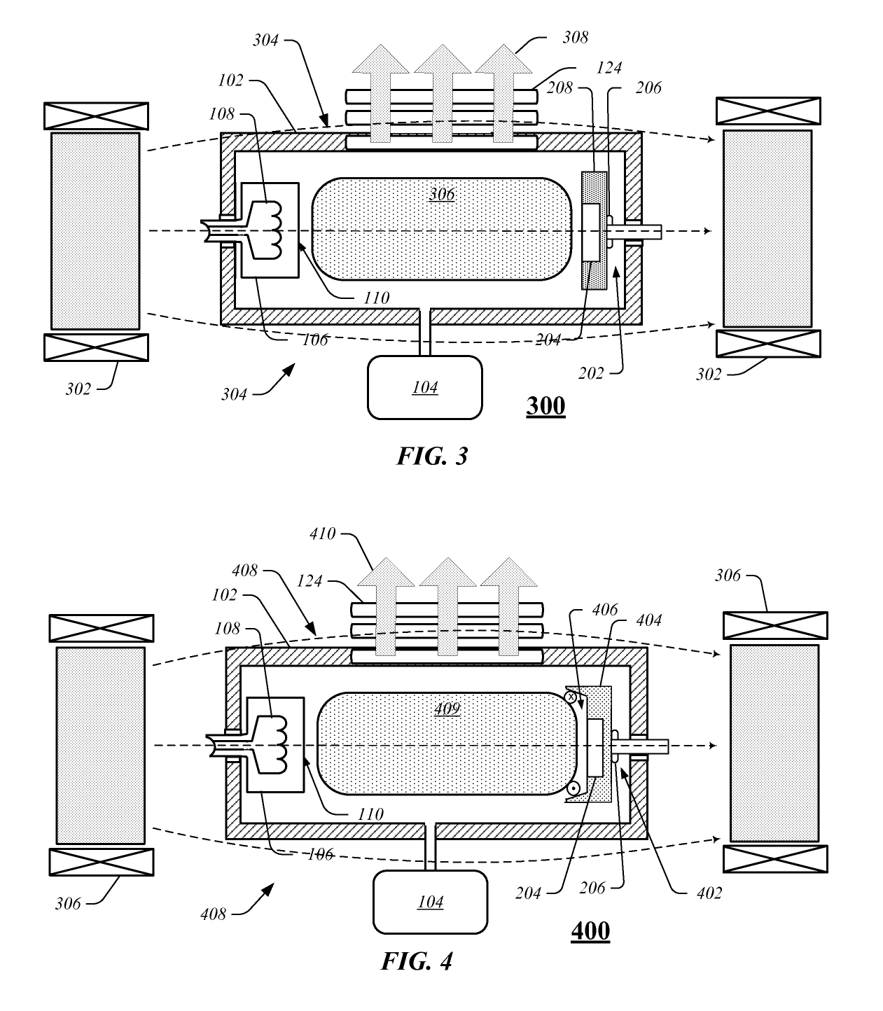

FIG. 3 depicts a further embodiment of an ion source 300, which is a variant of the ion source 200. The ion source 300 includes in addition to the components of ion source 200 as shown, a set of magnets 302 that are configured to generate a magnetic field 304 that extends generally parallel to the long axis 114. The set of magnets 302 provides electron confinement to aid in increasing plasma density of the plasma 306. The set of magnets 302 help confine electrons that may be originally emitted from the cathode 106 so that the electrons may bounce back and forth between cathode 106 and repeller assembly 202 to enhance ionizing collisions with process gas. The plasma 306 thereby created may have increased yield of ions thereby creating an ion beam 308 with higher beam current. At the same time etching of the phosphide insert 208 while the plasma 306 is ignited suppresses glitching and thereby increases overall operation lifetime of the ion source 300. In this manner substrate throughput is increased by virtue of increased ion beam current and decreased down time afforded by the ion source 300.

FIG. 4 depicts a further embodiment of an ion source 400, which is a variant of the ion source 300. In this case, the ion source 400 includes the same components as ion source 300 except that the repeller assembly 402 of ion source 400 differs from the repeller assembly 202. In particular a phosphide insert 404 is provided that presents a generally concave shape facing toward the cathode 106. This concave shape defines a confinement region 406. In particular, the concave shaped structure of the phosphide insert 404 in conjunction with the magnetic field 408 provide more effective confinement of primary electrons in the confinement region 406 and therefore enhance plasma generation. The cross and dot symbols in confinement region 406 represent E×B drift and therefore the electron confinement direction, where E-field is between the plasma 409 and the phosphide repeller 404, and B-field is shown as magnetic field 408. The increased plasma generation leads to greater ionization of boron and phosphorous species that may be etched from the phosphide insert 404 in embodiments where the phosphide insert 404 is boron phosphide. Accordingly, when used for boron ion implantation, for a given set of physical ion source dimensions and for a given ion current extracted from the plasma 409 of ion source 400 to form the ion beam 410, the overall process gas load or flow rate for BF₃ and/or B₂F₄ may be reduced in comparison to a conventional ion source that does not include the repeller assembly 402. This reduced flow of fluorine containing gaseous species results in reduced fluorine-based etching of metal surfaces within the ion source chamber 102, thereby reducing glitching that may result from such etching.

In further embodiments, an additional magnet may be located generally in the region between ion source chamber 102 and magnet 306 proximate the repeller assembly 402, which provides further local electron confinement.

In order to optimize the concentration or amount of phosphorous supplied to an ion source chamber during operation, various parameters may be adjusted. An optimum phosphorous amount may correspond to a gas phase phosphorous concentration that extends the stable operation of the ion source before glitching occurs without unduly compromising other desired characteristics of the ion source, such as the desired boron ion current for a given gas flow condition. For example, even though the use of a boron phosphide repeller insert may serve the dual function of reducing glitching and increasing boron ion current by providing an extra source of boron to the plasma, if too high a concentration of phosphorous ions is produced the boron ion concentration in the plasma may fall. In order to optimize phosphorous concentration, parameters such as repeller voltage, which determines ion energy of ions incident on the phosphide insert 122, and thereby the sputtering rate, the exposed surface area of the phosphide insert, and/or plasma density may be adjusted as appropriate. The repeller voltage may be adjusted dynamically during ion source operation, while the exposed surface area of a phosphide insert may be controlled off-line by changing the insert, for example. For example, it may be determined that the gas phase phosphorous concentration in the ion source increases with increased repeller voltage due to increased etching and sputtering of the phosphide insert by plasma species striking the phosphide insert. This increased gas phase phosphorous concentration may be reflected in a desired reduced glitching frequency of the ion source. However, as repeller voltage increases the concentration of boron ions in the plasma and therefore boron current in an extracted ion beam may tend to fall. For a given gas flow rate, the repeller voltage at which the boron ion current decreases below a target threshold may be deemed an upper limit or optimum repeller voltage for operation of the ion source.

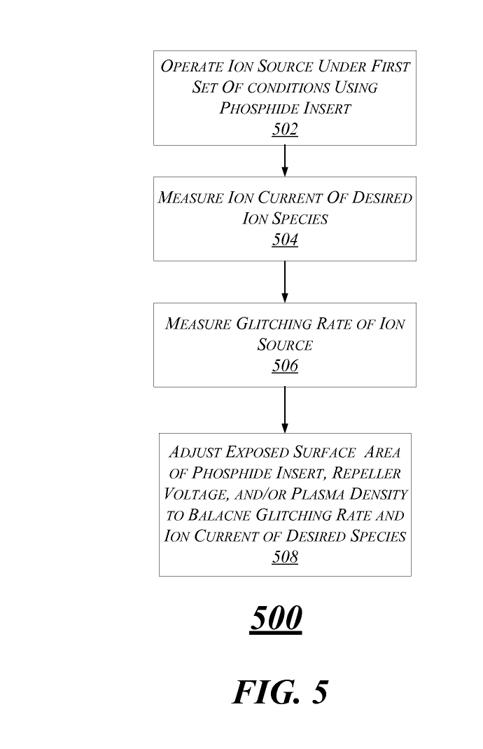

FIG. 5 depicts one exemplary process flow 500 consistent with embodiments of the disclosure. At block 502, an ion source is operated under a first set of conditions using a phosphide insert. The phosphide insert may be integrated, for example, within a repeller or repeller assembly. At block 504, ion current of a desired ion species is measured. The ion current is measured after extraction from the ion source and may be downstream of a mass analyzer to ensure that only the desired ion species is measured. At block 506 the glitching rate of the ion source is measured or recorded during operation of the ion source. At block 508, in order to balance or optimize the combination of ion current of the desired species, the exposed surface area of the phosphide insert is adjusted, the repeller voltage is adjusted, and/or the plasma density in the ion source is adjusted.

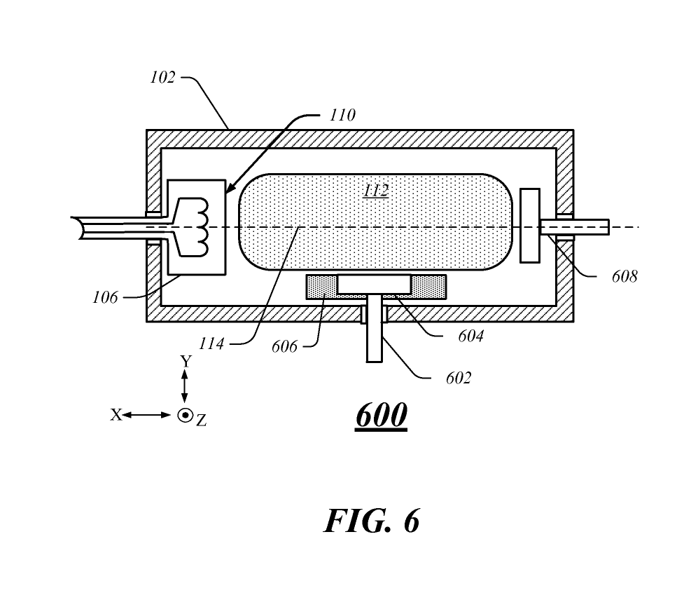

In various other embodiments, an ion source having a repeller assembly containing a phosphide insert may be employed in an otherwise conventional beamline apparatus for ion implantation of B, P, As, Si, or other species, each of which may be derived from a halogen-containing precursor species. Examples of halogen species that may be used as precursors for ions generated by the ion source 100 include BF₃, PF₃, SiF₄, B₂F₄, AsF₅, GeF₄ among other species. Moreover halogen species include products of another halogen species. For example, BF₃ gas may be provided to the ion source and BF₃ ions, BF₂ neutrals, BF₂ ions, BF neutrals, BF ions, and F neutrals, F positive and negative ions and other heavy neutral radicals or ions BₓF_{y} among others may all be produced through one or more processes from the parent BF₃ gas and are all deemed to be halogen species. The embodiments are not limited in this context. Moreover, in additional embodiments, the phosphide insert may be located within an ion source chamber separately from a repeller assembly. For example, the phosphide insert may be integrated into an independently biased electrode assembly that faces the ion source plasma and is separate from the cathode and repeller assembly. The separate electrode may thereby be used to independently control the amount of phosphorous introduced into the ion source chamber 102 during operation. FIG. 6 is a top cross-sectional view of a further ion source 600 consistent with additional embodiments of the disclosure. The ion source 600 includes an electrode 602 that has a conductive electrode body 604 and phosphide insert 606 that presents a surface toward the plasma 112. The repeller 608 in this embodiment does not have a phosphide insert but may be composed of a single material such as tungsten.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the subject matter of the present disclosure should be construed in view of the full breadth and spirit of the present disclosure as described herein.

What is claimed is:

1. An ion source, comprising:
an ion source chamber;
a gas source to provide a fluorine-containing dopant gas species to the ion source chamber;
a cathode disposed in the ion source chamber and configured to emit electrons to generate a plasma within the ion source chamber, the ion source chamber and cathode comprising a refractory metal; and
a repeller assembly disposed opposite the cathode, wherein the repeller assembly comprises:
an electrically conductive repeller body configured to receive a repeller voltage to attract ions from the plasma; and
a phosphide insert,
wherein the repeller body is disposed in a middle section of the repeller assembly and the phosphide insert is disposed around the repeller body, and wherein
the phosphide insert presenting an exposed surface area that is configured to generate gas phase phosphorous species when the plasma is present in the ion source chamber, wherein the phosphide insert comprises boron phosphide, tungsten phosphide, aluminum phosphide, nickel phosphide, calcium phosphide, or indium phosphide.

2. The ion source of claim 1, wherein the ion source chamber comprises an elongated shape having a long axis, wherein the repeller assembly is disposed opposite the cathode along the long axis, wherein the repeller further assembly comprises:
a clamp, the electrically conductive repeller body and clamp configured to retain the phosphide insert, wherein the phosphide insert and electrically conductive repeller body define a front surface facing the plasma, wherein the phosphide insert comprises less than 100% of the front surface.

3. The ion source of claim 2, wherein the phosphide insert comprises a planar shape in which at least a planar surface of the phosphide insert that is disposed generally opposite the cathode is exposed to the plasma.

4. The ion source of claim 2, further comprising a magnet configured to generate a magnetic field parallel to the long axis, wherein the phosphide component presents a generally concave shape to the plasma, the concave shape defining an interior region, wherein the phosphide component and magnet are configured to create electron confinement within the interior region.

5. The ion source of claim 2, wherein the repeller voltage is the same as a cathode voltage applied to the cathode to generate the plasma.

6. The ion source of claim 1, wherein the phosphide insert comprises boron phosphide, wherein boron ion current extracted from the ion source under a first set of operating conditions is greater than when the ion source is operated under the first set of operating conditions without the phosphide insert.

7. The ion source of claim 1, wherein the fluorine-containing gas species are hydrogen-free.

8. The ion source of claim 1, wherein the cathode is an indirectly heated cathode configured to operate at temperatures at least in the range of 2000° C. to 3000° C.

9. (canceled)

10. A method to operate an ion source, comprising:
providing a gaseous fluorine-containing species to an ion source chamber comprising refractory metal;
providing a cathode voltage to a refractory metal cathode in the ion source chamber to generate a plasma therein;
providing, opposite the cathode, a repeller assembly that includes a repeller body and a phosphide insert,
wherein the repeller body is disposed in a middle section of the repeller assembly and the phosphide insert is disposed around the repeller body,
wherein the phosphide insert presenting an exposed surface area that is configured to generate gas phase phosphorous species when the phosphide insert is exposed to the plasma, and
wherein the phosphide insert comprises boron phosphide, tungsten phosphide, aluminum phosphide, nickel phosphide, calcium phosphide or indium phosphide.

11. The method of claim 10, further comprising:
providing the ion source chamber with an elongated shape having a long axis;
providing the repeller assembly opposite the cathode along the long axis; and
providing a clamp to retain the phosphide insert.

12. The method of claim 11, further comprising providing the phosphide insert as a planar shape in which a planar surface of the phosphide insert is exposed to the plasma.

13. The method of claim 11, further comprising:
generating a magnetic field parallel to the long axis; and
providing the phosphide component with a generally concave shape with respect to the plasma, the generally concave shape defining an interior region, wherein the phosphide component is configured with the magnetic field to generate electron confinement within the interior region.

14. The method of claim 11, further comprising providing a repeller voltage to the repeller assembly that is the same as the cathode voltage.

15. The method of claim 10, further comprising providing the phosphide insert as boron phosphide, wherein boron ion current extracted from the ion source under a first set of operating conditions is greater than when the ion source is operated under the first set of operating conditions without the phosphide component.

16. The method of claim 10, further comprising adjusting a generation rate of gas phase phosphorous species by adjusting one or more of: the repeller voltage, exposed surface area of the phosphide insert, and plasma density.

17. An ion source, comprising:
an ion source chamber;
a gas source to provide a fluorine-containing dopant gas species to the ion source chamber;
a cathode disposed in the ion source chamber and configured to emit electrons to generate a plasma within the ion source chamber, the ion source chamber and cathode comprising a refractory metal;
a repeller disposed opposite the cathode; and
an electrode assembly that faces the plasma and is configured to receive a bias voltage independently of the cathode and repeller, the electrode assembly comprising:
a conductive electrode body configured to receive the bias voltage; and
a phosphide insert, wherein the conductive electrode body is disposed in a middle section of the electrode assembly and the phosphide insert is disposed around the conductive electrode body, and wherein the phosphide insert presents an exposed surface area that is configured to generate gas phase phosphorous species when the plasma is present in the ion source chamber.

18. The ion source of claim 17, wherein the phosphide insert comprises boron phosphide, tungsten phosphide, aluminum phosphide, nickel phosphide, calcium phosphide, or indium phosphide.

19. The ion source of claim 17, wherein the phosphide insert and conductive electrode body define a front surface facing the plasma, wherein the phosphide insert comprises less than 100% of the front surface.
